(19) United States
(12) Patent Application Publication
(10) Pub. No.: US 2009/0044278 A1
(43) Pub. Date: Feb. 12, 2009

(54) METHOD OF TRANSMITTING DRM CONTENT

(76) Inventor: Ji Hyun Lim, Suwon-si (KR)

Correspondence Address: MORGAN, LEWIS & BOCKIUS LLP (SF), One Market, Spear Street Tower, Suite 2800, San Francisco, CA, 94105, US

(21) Appl. No.: 11/959,062

(22) Filed: Dec. 18, 2007

(30) Foreign Application Priority Data
Aug. 6, 2007 (KR) 10-2007-0078590

(51) Int. Cl. G06F 21/00; H04L 9/00

(52) U.S. Cl. 726/26

(57) ABSTRACT

Disclosed herein is a method of transmitting DRM content, stored in a device, to another external device. A rights object is embedded in a mutable information box of a Digital rights management Content Format (DCF), thus integrating the rights object and the DCF into a single object. The DCF, in which the rights object is embedded, is transmitted with a message authentication code. The message authentication code is embedded in the mutable information box of the DCF so as to enable integrity validation for the DCF, in which the rights object is embedded. The rights object is a domain rights object capable of being shared by one or more devices. The DCF, in which the rights object is embedded, is transmitted to the external device via mobile storage in which no security function exists or no security function is set.

### CROSS REFERENCE TO RELATED APPLICATIONS

This application claims priority to Korean Application No. 10-2007-0078590, filed on Aug. 6, 2007, the disclosure of which is incorporated herein by reference.

### BACKGROUND OF THE INVENTION

1. Field of the Invention

The present invention relates generally to Digital Rights Management (DRM). More particularly, the present invention relates to a method of transmitting DRM content, which allows DRM-Protected Content to be conveniently transferred between different devices, and enables DRM content, purchased by a DRM content user, to be transmitted to a separate external device, especially an unconnected device, thereby allowing the content to be played in the unconnected device.

The term “unconnected device”, as defined in the present invention, means a device that is not connected to a network and is incapable of obtaining a right to DRM content, in particular, a media player. A representative example of such an unconnected device is car audio equipment. An unconnected device is characterized in that it is provided with a wired communication module, such as a Universal Serial Bus (USB) port, and is thus able to exchange data with external devices, but cannot be directly connected to a PC or network through the wired communication module due to the characteristics of the use thereof.

2. Description of the Related Art

A demand for the protection of digital content, such as images, music, video, or games, still exists with the development of the wired Internet, and this demand has resulted in the development of Digital Rights Management (DRM) technology. However, due to the characteristics of the wired Internet environment, in which the illegal duplication, modification and transmission of content using a PC can be performed very freely, the protection and distribution management of content based on the DRM technology are not highly effective yet.

However, recently, digital rights management in the mobile communication industry has shown some features considerably different from those of the wired Internet. That is, control can be performed so that content used in portable terminals or handset devices is downloaded only through a specific content provision system. Therefore, an increase in the number of downloads of content can immediately result in an increase in profit. Accordingly, the application of DRM technology to guarantee the free distribution of content and the use of content by authorized users has become the focus of interest to the mobile communication service providers and the content provision servers, and has consequently resulted in the standardization of DRM technology.

FIG. 1 is a diagram showing the basic concept of a conventional DRM system for protecting content and managing the distribution of the content.

As shown in FIG. 1, a DRM system includes a content provision server 10, a rights issuing server 20, and a certificate issuing server 30.

According to the DRM system, when a user A 40a intends to download content from the content provision server 10 and play the downloaded content, the user A 40a must be additionally provided with a certificate issued by the certificate issuing server 30 and a Rights Object (RO) to corresponding content issued by the rights issuing server 20. Meanwhile, downloaded content can be transmitted from the user A 40a to a user B 40b. In this case, in order to play received content, the user B 40b must be assigned a rights object to use the received content. According to the DRM technology, content can be freely distributed, but can be used only through a specific device that is authenticated and assigned a rights object for the content to be used by the DRM system.

Such a conventional DRM system is problematic in that a device must be connected to a network through a mobile phone or a PC in order to distribute and use content. In the case of an unconnected device, which cannot be connected to a network, since tile status of whether the device is an authorized device cannot be determined through the authentication of the device, it is currently impossible to play content protected by DRM using the unconnected device. For example, in the case of a vehicle equipped with Telematics, the vehicle can be connected in real time to a network, and thus DRM content can be freely used without limitation. However, in the case of most vehicles, which are not equipped with Telematics, the owners of the vehicles cannot play downloaded content through their car audio equipment even if they are authorized content users.

However, as the distribution of digital content increases, the necessity to charge for content and utilize DRM technology has been emphasized, and has been propagated to various industries, such as the automobile industry, as well as the IT field. Therefore, association between a service provider, having an extensive infrastructure in music services, and unconnected devices, in particular, various types of media players provided in vehicles having an excellent music playback environment, is required.

Meanwhile, an example of the prior art that can be referred to in relation to the present invention is disclosed in U.S. Patent Publication Nos. 20050216763, 20050268346, and 20050210236. These patents propose a scheme for utilizing a portable storage device to facilitate the transfer of rights objects and encrypted content between devices. However, the portable storage device used in the above patents is a storage device, such as a Multimedia Memory Card (MMC) capable of communicating with a device and analyzing a rights object under a powerful security structure, rather than a simple storage device such as a USB memory stick. For this function, a storage device must be equipped with a small-sized microcomputer, and thus the structure of the storage device is complicated and the cost of the storage device is increased. Consequently, costs that must be paid by users to use DRM content are inevitably increased.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

Accordingly, the present invention has been made keeping in mind the above problems occurring in the prior art, and an object of the present invention is to provide a method of transmitting DRM content, which allows DRM content to be conveniently and freely transferred between different devices.

Another object of the present invention is to provide a method of transmitting DRM content, which enables DRM content, purchased by a DRM content user, to be transmitted to the user's own unconnected device, which is not connected to a network, thereby allowing the DRM content to be played in the unconnected device.

Still another object of the present invention is to provide a method of transmitting DRM content, which prevents DRM content from being illegally used, even when mobile storage, having a simple storage function, such as a Universal Serial Bus (USB) stick, is used.

In order to accomplish the above-described objects, the present invention provides a method of transmitting DRM content. When content is transferred to another external device, a rights object is embedded in a mutable DRM information box of a DRM Content Format (DCF), so that the rights object and the DCF are integrated into a single object form, and thus the integrated single object form is transmitted. Here, a message authentication code is embedded in the mutable DRM information box, and then transmitted, so as to enable integrity validation for the DCF, in which the rights object is embedded. According to this method, the rights object can be prevented from being illegally extracted, altered, or manipulated by a user. Furthermore, the rights object can be prevented from being unintentionally damaged by a user. A device, which received a DCF, can play the DRM content only when the integrity of the DCF is recognized. An HMAC-SHA1 algorithm may be used as a security algorithm for constructing an authentication code.

According to the present invention, the rights object is a domain rights object shared by one or more devices, that is, a device group. Since a conventional DRM system is constructed to allow only a specific device, authenticated by the DRM system, to extract a content decoding key from a rights object, the DRM service cannot be supported by an unconnected device, incapable of directly receiving a rights object through a network. In order to solve this problem, the present invention is constructed such that devices within a specific group can share rights objects, that is, domain rights objects, with each other.

According to the method of providing DRM content, mobile storage, such as a USB memory stick, which has no security function and has a simple storage function, can be used to transfer DRM content to another external device. Of course, the possibility that mobile storage, such as a Secure Digital (SD) card, which has a security function, can be used is not excluded. However, it should be understood that the present invention chiefly aims to transmit DRM content via a USB memory stick, which is widely distributed and inexpensive.

Preferably, when transmitting a DCF in which a rights object is embedded to an external device, it is preferable that a device authentication code for identifying a target device be created, and that the created device authentication code be transmitted together with the DCF. A device authentication code is created in an encrypted form so that a user cannot easily check it. A key, used when an authentication code is created, is required to be constructed by a secret key which can be checked by a DRM transmitting device, such as a Personal Computer (PC), and a target device. Further, this secret key is processed through a specific security algorithm, so that the secret key is used as a master key for hash-based message authentication code data. In the case where a credential file including an authentication code does not exist, or device validation fails, DRM content cannot be played in a target device.

When a DCF, in which a rights object is embedded, is transmitted to an external device, the playlist file of DRM content can be transmitted together with the DCF. A target device, which received a DCF, can display a DRM content list using the playlist file.

Meanwhile, a target device may be car audio equipment, which includes an unconnected device, especially a USB port or a memory card slot.

According to the method of transmitting DIM content constructed as described above, since DRM content can be transferred to one or more external devices, which share a domain rights object, using mobile storage, the DRM content can be conveniently and freely transmitted.

Further, since DRM content, purchased by a DRM content user, is transmitted to an unconnected device using mobile storage, content can be played even in the unconnected device.

Furthermore, even when DRM content is transmitted using mobile storage, such as a USB memory stick, which has only a simple storage function, the DRM content can be prevented from being illegally used.

The above features and advantages of the present invention will be apparent from or are set forth in more detail in the accompanying drawings, which are incorporated in and form a part of this specification, and the following Detailed Description of the Invention, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings, which are given hereinbelow by way of illustration only, and thus are not limitative of the present invention, and wherein:

FIG. 1 is a schematic diagram showing the structure of a conventional DRM system;

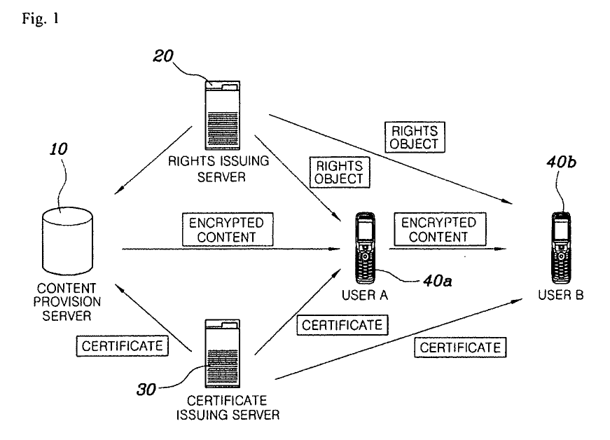

FIG. 2 is a conceptual diagram showing a method of transmitting DRM content according to the present invention;

FIG. 3 is a schematic diagram showing the structure of a DCF according to an embodiment of the present invention; and

FIG. 4 is a diagram showing a method of transmitting DRM content according to an embodiment of the present invention.

However, it should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DESCRIPTION OF PREFERRED EMBODIMENTS

Hereinafter reference will now be made in detail to a preferred embodiment of the present invention, an example of which are illustrated in the accompanying drawings and described below. While the invention will be described in conjunction with an exemplary embodiment, it will be understood that present description is not intended to limit the invention to the exemplary embodiment. On the contrary, the invention is intended to cover not only the exemplary embodiment, but also various alternatives, modifications, equivalents and other embodiments, which may be included within the spirit and scope of the invention as defined by the appended claims.

Reference now should be made to the drawings, in which the same reference numerals are used throughout the different drawings to designate the same or similar components.

A method of transmitting DRM content according to preferred embodiments of the present invention will be described in detail with reference to accompanying drawings below.

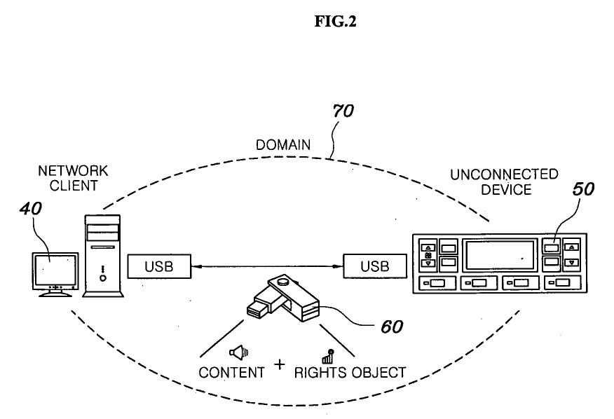

FIG. 2 is a conceptual diagram showing a method of transmitting DRM content according to the present invention.

The method of transmitting DRM content according to the present invention chiefly aims to transmit DRM content, purchased by a user, to an external device, especially an unconnected device 50, from a network client 40 using mobile storage 60, such as a USB memory stick, and play the DRM content in the external device. In addition, in order to enable the super distribution of DRM content using such mobile storage 60, the network client 40 and the unconnected device 50 should subscribe to the same domain 70, and a domain rights object stored in the mobile storage 60 should be prevented from being arbitrarily extracted, altered, or manipulated.

First, a procedure of preventing a domain rights object from being manipulated arbitrarily, which is provided in the present invention, will be described in brief below.

In order to provide a rights object to a target device, especially an unconnected device, via mobile storage, having a simple storage function, the following security requirements should be satisfied.

First, a rights object should not be stored in an independent file form. The reason for this is to prevent a rights object from being intentionally altered by a user and being unintentionally damaged by the user.

Second, integrity validation is essentially required to determine whether a rights object has been altered or damaged.

In order to satisfy such requirements, the present invention employs a method of embedding a corresponding domain rights object in a DRM Content Format (DCF), integrating the rights object and the DCF into a single object, and storing the integrated object in mobile storage. Besides a DCF hash value, stored in the DCF to validate the integrity of the DCF, the Message Authentication Code (MAC) value of the DCF, in which the rights object is embedded, is constructed and then embedded in the DCF, along with the rights object, so as to validate the integrity of the DCF. Hash Based Message Authentication Code (HMAC)-Secure Flash Algorithm 1 (SHA1) is used as a security algorithm, required to construct such a MAC, and a secret key, capable of being shared by a target device, is used as a MAC key, that is, a master key, used for validation of the HMAC.

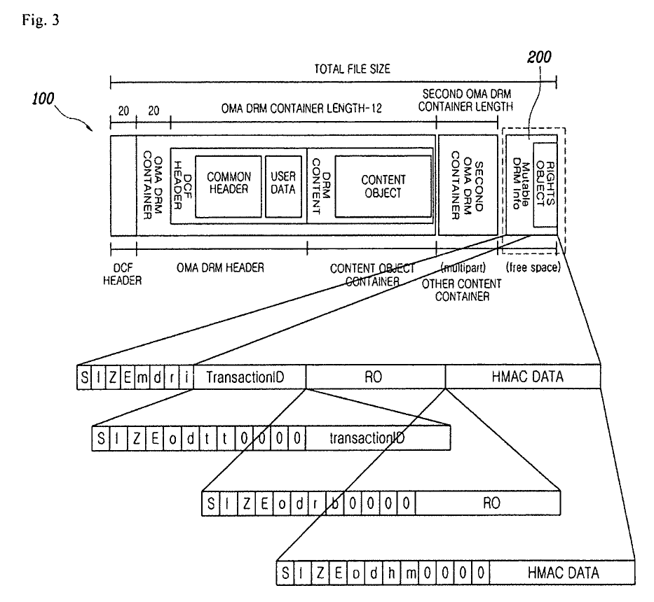

Referring to FIG. 3, a method of embedding a rights object and HMAC data in a DCF 100 will be described in detail. Techniques which are not described here follow the typical known art.

A DCF packaging structure may follow the Open Mobile Alliance (OMA) DRM v2.0 DCF standard, and a rights object and HMAC data are embedded in a multiple DRM information box 200. The structure of the box 200 includes four-byte size information, indicating the total size of the box 200, a box brand name, a box version, and actual data. Items included in the box 200 are distinguished using box brand names. Box brand names corresponding to respective items are as follows:

mdri: The brand name of the mutable DRM information box 200 of a DCF, which can be manipulated.

odtt: The brand name of a box in which a transaction ID is embedded. In order to track the path of a DCF when the DCF is super-distributed, a transaction ID is issued by a rights issuing server, and is embedded in the DCF by a DRM agent.

odrb: The brand name of a box in which a rights object is embedded.

odhm: The brand name of a box in which a MAC value is embedded so as to perform integrity validation for a DCF, in which a rights object is embedded.

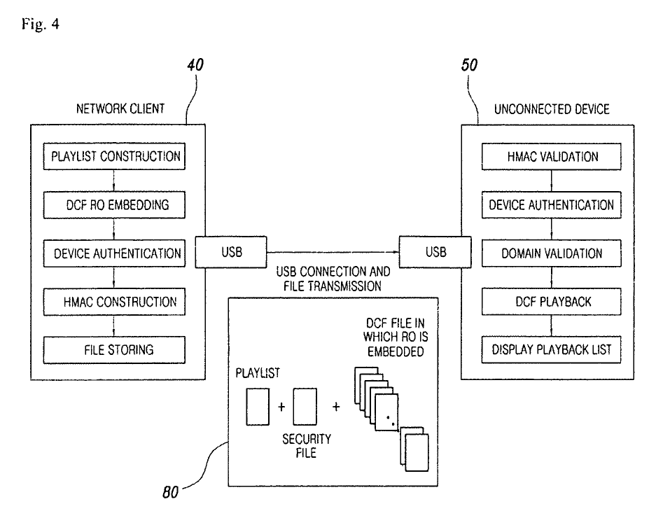

Referring to FIG. 4, a method of transmitting DRM content to an unconnected device 50 from a network client 40 will be described.

As shown in FIG. 4, DRM content and a rights object, which a user has downloaded using the network client 40, are stored in a USB memory stick, and are then transmitted to the unconnected device 50. The network client 40 may be a Personal Computer (PC), and the unconnected device 50 may be car audio equipment.

In order to receive content from the network client 40 and play the received content in the unconnected device 50, the network client 40 and unconnected device 50 must be registered in the same domain. Therefore, a procedure of registering the unconnected device 50 in a domain is required. The procedure may be performed in a state in which the unconnected device 50 is connected to a DRM system via a handset device, capable of performing wireless communication. The handset device, a PC, and the unconnected device are all required to be registered in the same domain, and the unconnected device 50 is required to be equipped with at least a USB module for connection to the handset device.

An object file 80, stored in the USB memory stick and transmitted to the unconnected device 50, includes a DCF, in which a rights object is embedded, a playlist file, in which a list of a plurality of pieces of content is constructed as a file, and a security file, which contains an authentication code for performing the identification or authentication of a target device, that is, the unconnected device 50.

The flow of the transmission of the object file 80 from a network client 40 to a target device, i.e, unconnected device 50, and playing of the object file 80, is as follows shown in FIG. 4:

### Step of Transmission in Network Client

1) Playlist Construction: A playlist of content to be stored in mobile storage is constructed in an Extensible Markup Language (XML) form at step of S41. For the construction of such a playlist, a window media playlist or a playlist, such as the Moving Picture Experts Group-Audio Layer 3 Uniform Resource Locator (M3U) or Playlist (PLS) of Winamp, may be used. For example, since the file path of a USB file system and basic content meta-information can be included in a playlist file, content information can be displayed using the playlist file.

2) DCF Rights Object Embedding: A domain rights object is embedded in the mutable DRM information box of a DCF at step of S42.

3) Device Authentication: A user directly inputs the identification code of an unconnected device 50 to a network client 40, or registers the identification code in the network client 40 in advance, thereby creating the authentication code of the unconnected device 50, and then the authentication code is stored in mobile storage as a security file at step of S43. Further, the network client 40 creates a secret key, together with a device authentication code, which will be used as the master key of an HMAC. The same key creation logic (key derivation function) is constructed both in the network client 40 and in the unconnected device 50.

4) HMAC Construction: An HMAC is constructed for a DCF, in which a rights object is embedded, and the value of the HMAC is embedded in the mutable DRM information box of a DCF at step of S43.

5) File Storing: A DCF file, in which a playlist, a device authentication code, and a rights object arc embedded, is stored in mobile storage at step of S44.

### Step of Playback in Target Device

1) HMAC Validation: When a DCF, stored in mobile storage, is desired to be played, the value of an HMAC included in a mutable information box is checked first, so that the fact that the DCF, in which a rights object is embedded, has not been forged is validated at step of S51. Meanwhile, an unconnected device 50 may be provided with separate memory, and a DCF may be stored in the separate memory.

2) Device Authentication: The unconnected device 50 parses a device authentication code constructed in a network client 40, and then checks whether content can be played in the unconnected device 50 at step of S52. In the case where no security file exists or validation fails, the content cannot be played.

3) Domain Validation: A rights object embedded in the DCF is extracted, and a domain IDentification (ID), referenced in the rights object is detected, so that domain context is detected using the domain ID, and thus a domain key is formed at step of S53.

4) DCF Playback: A Content Encryption Key (CEK) is demodulated using the domain key, and then packaged content is played back at step of S54. The range of use of content depends on permission and constraints defined in the rights object.

5) Playlist Display: The unconnected device 50 parses a playlist file stored in a USB when necessary, and displays content information at step of S55.

The forgoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiment were chosen and described in order to explain certain principles of the invention and their practical application, to thereby enable others skilled in the art to make and utilize various exemplary embodiments of the present invention, as well as various alternatives and modifications thereof. It is intended that technical spirit and scope of the present invention be defined by the Claims appended hereto and their equivalents.

What is claimed is:

1. A method of transmitting DRM content, stored in a device, to another external device, comprising:
embedding a rights object in a mutable information box of a Digital rights management Content Format (DCF), thus integrating the rights object and the DCF into a single object, and transmitting the DCF, in which the rights object is embedded, with a message authentication code being embedded in the mutable information box of the DCF so as to enable integrity validation for the DCF, in which the rights object is embedded;
wherein the rights object is a domain rights object capable of being shared by one or more devices.

2. The method of transmitting DRM content as set forth in claim 1, wherein the message authentication code is constructed using a Hash-based Message Authentication Code (HMAC)-Secure Hash Algorithm 1 (SHA1), and a master key for the message authentication code is created using a specific security algorithm.

3. The method of transmitting DRM content as set forth in claim 1, wherein the transmitting the DCF, in which the rights object is embedded, to the external device is performed via mobile storage, in which no security function exists or no security function is set.

4. The method of transmitting DRM content as set forth in claim 3, wherein the transmitting the DCF, in which the rights object is embedded, via mobile storage comprises:
creating a device authentication code for identifying a target device; and
transmitting the device authentication code, together with the DCF.

5. The method of transmitting DRM content as set forth in claim 4, wherein a secret key, used when the device authentication code is created, is reprocessed through a specific security algorithm and is then used as a master key for the message authentication code.

6. The method of transmitting DRM content as set forth in claim 4, wherein the target device is an unconnected device.

7. The method of transmitting DRM content as set forth in claim 6, wherein the target device is car audio equipment, including at least a Universal Serial Bus (USB) port or a memory card slot.

8. The method of transmitting DRM content as set forth in claim 1, wherein the transmitting the DCF, in which the rights object is embedded, to the external device comprises transmitting a playlist file for the DRM content, together with the DCF.
